(19) United States
(12) Patent Application Publication
(10) Pub. No.: US 2001/0011686 A1
(43) Pub. Date: Aug. 9, 2001

(54) Fuel injection apparatus

(76) Inventor: Hiroshi Kuzuyama, Aichi-ken (JP)

Correspondence Address: Kurt E. Richter, Morgan & Finnegan, L.L.P., 345 Park Avenue, New York, NY, 10154, US

(21) Appl. No.: 09/776,310

(22) Filed: Feb. 2, 2001

(30) Foreign Application Priority Data
Feb. 3, 2000 (JP) 2000-026454

(51) Int. Cl. F02M 47/02; F02M 47/04

(52) U.S. Cl. 239/88; 239/533.9

(57) ABSTRACT

A fuel injection apparatus includes a valve closing unit provided for biasing a needle valve by a pressure of working fluid introduced into a pressure controlling chamber and a biasing force of a needle spring. A working fluid introducing/backing passage having a port is connected to the pressure controlling chamber. A throttle portion for imparting a fluidization resistance to the working fluid is provided in the port. The port is adapted to be kept in communication with the working fluid discharge passage only in a retracted position of a booster piston, to be in communication with a pressurizing chamber only in the case where the booster piston is advanced through a predetermined distance or longer, and to be in communication with none of the working fluid discharge passage and the pressurizing chamber from the retracted position to the advanced position through the predetermined distance.

### BACKGROUND OF THE INVENTION

1. Field of the Invention

The present invention relates to a fuel injection apparatus.

2. Description of the Related Art

Two types of fuel injection apparatus have been proposed. One is an accumulator fuel injection apparatus in which fuel that has been pressurized up to a predetermined pressure in advance is injected, and the other is a booster type in which the pressure of fuel is boosted upon the injection.

As described later and as shown in FIG. 8, in the accumulator type fuel injection apparatus, since the pressure of fuel has been boosted, the fuel injection rate is abruptly increased immediately after the valve opening. Also, since the boosted pressure of fuel may be utilized upon the valve closure, the fuel injection rate is abruptly decreased. On the other hand, as shown in FIG. 9, in the booster type fuel injection apparatus, since the pressure of fuel is boosted upon the fuel injection, the rise of the fuel injection rate immediately after the valve opening becomes more moderate. Also, since the boosted pressure of fuel could not be used and the valve closure is performed only by a spring force upon the valve closure, the reduction in fuel injection rate is moderated.

However, either of the conventional accumulator type and booster type apparatuses suffer from a problem in that it is impossible to keep the exhaust gas under the optimum condition and so on.

More specifically, in view of the characteristics of an engine, it is possible to suppress the generation of vibration, combustion noise or NOx at a low fuel injection rate more than at a high fuel injection rate in an initial stage of one fuel injection. In contrast, in the accumulator fuel injection apparatus, the fuel injection rate upon the fuel injection start becomes abruptly too high.

Further, in the final stage of one fuel injection, it is possible to suppress the generation of particulate or unburned fuel in the case where the fuel injection rate is abruptly lowered more than the case where the rate is gradually lowered. In contrast, in the booster type fuel injection apparatus, the decrease of the fuel injection rate upon the fuel injection interruption is too slow.

Thus, the conventional accumulator type and booster type fuel injection apparatuses suffer from the problem either in the injection start or in the injection interruption.

It has been thus desired to provide a fuel injection apparatus having such characteristics that the fuel injection rate is gradually increased upon the fuel injection start as in the booster type fuel injection apparatus and the fuel injection rate is abruptly decreased in the fuel injection interruption as in the accumulator fuel injection apparatus.

On the other hand, in Japanese Patent Application Laid-open No. 10-103185, there is shown a fuel injection apparatus that is constructed so as to control two valves, i.e., a valve for controlling the boost of fuel and a valve for controlling the pressure given upon the opening and closing of a needle valve by using two solenoids. This fuel injection apparatus changes the pressure given upon the opening and closing of the needle valve to thereby make it possible to adjust the fuel injection rate upon the fuel injection start and interruption. However, in this case, it is necessary to provide two solenoids and two valves, resulting in the complication of the structure to increase the number of mechanical parts, which leads to the large size of the apparatus and increase of the cost.

Further, Japanese Patent Application Laid-open No. 10-110658 shows a fuel injection apparatus that is constructed so as to operate two valves by using only one solenoid and to change the pressure given upon the opening and closing of a needle valve by one valve. In this case, although it is possible to reduce the number of the solenoids down to one, there is a problem in that the structure and mechanism of the apparatus would be very complicated to degrade the reliability of the operation.

### SUMMARY OF THE INVENTION

The present invention has been made in view of the above-mentioned problems inherent in the prior art, and therefore has an object to provide a fuel injection apparatus that may keep the fuel injection rate upon the fuel injection start and the fuel injection interruption under the optimum condition and that has a high reliability with a relatively simple structure.

According to the present invention, there is provided a fuel injection apparatus, characterized in that said apparatus comprising:

a valve body portion including a nozzle chip provided with a fuel injection port and a needle valve disposed movably back and forward within the nozzle chip for opening and closing the fuel injection port;

a booster means for advancing a booster piston, movable back and forward and biased backwardly by a piston spring, against a biasing force of the piston spring by a pressure of working fluid introduced into a pressurizing chamber to increase the pressure of fuel within a booster chamber;

a valve controlling means including a feeding port for communicating the pressurizing chamber and a working fluid supply source with each other, a discharge port for communication with the pressurizing chamber and a working fluid discharge passage, a booster valve for opening and closing the feeding port and the discharge port, a valve spring for closing the feeding port and biasing the booster valve toward a pressure decreasing position where the discharge port is released, and a solenoid for releasing the feeding port and moving the booster valve to a booster position where the discharge port is closed;

a valve opening means for biasing the needle valve in a direction in which the fuel injection port is released by the boosted pressure of fuel; and

a valve closing means for biasing the needle valve in a direction in which the fuel injection port is closed by a pressure of working fluid introduced into a pressure controlling chamber and a biasing force of a needle spring; and

characterized in that a working fluid introducing/backing passage having a port for performing introduction and discharge of the working fluid is connected to the pressure controlling chamber, and a throttle portion for imparting a fluidization resistance to the working fluid is provided in the port; and

wherein the port is adapted to become a condition in which it is in communication with the working fluid discharge passage only at the retracted position of the booster piston, to become a condition in which it is in communication with the pressurizing chamber only in the case where the booster piston is advanced through a predetermined distance or longer, and to become a closed condition in which it is in communication with none of the working fluid discharge passage and the pressurizing chamber from the retracted position to the position through the predetermined distance.

The effect of the invention will now be described.

In the fuel injection apparatus, when the fuel is to be injected, first of all, the booster valve is moved to the booster position by the solenoid of the valve controlling means. Thus, the discharge port is closed, and at the same time the feeding port is opened. The pressurizing chamber of the booster means and the working fluid supply source are in communication with each other. Thus, the working fluid is introduced into the pressurizing chamber to increase the pressure of the pressurizing chamber.

In accordance with an increase in the pressure of the pressurizing chamber, the booster piston is gradually advanced so that the pressure of the fuel within the booster chamber is gradually increased. In accordance with this boost of the fuel, the valve opening force for biasing the needle valve in the valve opening direction is gradually increased in the valve opening means.

On the other hand, before the start of the advancement of the booster piston, the port of the working fluid introducing/backing passage connected to the pressure controlling chamber is kept in communication with the working fluid discharge passage. For this reason, the pressure controlling chamber is kept under the low pressure condition before the start of boost. The valve closing force for biasing the needle valve in the valve closing direction is kept only by the biasing force of the needle spring.

Further, after the start of the boost of pressure, since the port is closed until the booster piston is advanced through the predetermined distance, the interior of the pressure controlling chamber is kept under the low pressure condition.

For this reason, at the time the valve opening biasing force obtained by the boost of the fuel overcome the biasing force of the needle spring, the needle valve is moved in the valve opening direction and the fuel injection port is opened to start the fuel injection.

Then, in accordance with the further advancement of the booster piston, the pressure boost of fuel is further accelerated so that the fuel injection rate of fuel to be injected is increased in accordance with this.

At the time the booster piston has been advanced through the predetermined distance or longer, the port in the pressure controlling chamber is in communication with the pressurizing chamber. For this reason, the working fluid is introduced from the pressurizing chamber through the throttle portion of the port and the working fluid introducing/backing passage to the pressure controlling chamber. Thus, the pressure of the pressure controlling chamber is increased and kept under the high pressure condition.

Subsequently, when the fuel injection is to be interrupted, the operation of the solenoid of the valve controlling means is stopped. Thus, the booster valve is returned back to the pressure decreasing position by the biasing force of the valve spring. Thus, the feeding port is closed and at the same time, the discharge port is opened. Therefore, the pressurizing chamber is in communication with the working fluid discharge passage to be abruptly changed to the pressure decreasing condition.

The advancement of the booster piston is stopped by the decrease in pressure of the pressurizing chamber, and the retraction is started. Thus, the pressure of fuel is decreased so that the valve opening force in the valve opening means becomes small.

On the other hand, according to the pressure decrease of the pressurizing chamber, the working fluid kept under the high pressure condition within the pressure controlling chamber is discharged through the port. However, since the throttle portion is provided in the port, the discharge of the working fluid is suppressed to a very slow flow rate. Therefore, the sufficiently high pressure is maintained within the pressure controlling chamber immediately after the stop of the boost.

Thus, at the moment the pressure of fuel is decreased and the valve opening force becomes small, the large valve closing force resultant from the combination of the high pressure of the pressure controlling chamber and the biasing force of the needle spring is given to the needle valve. The needle valve is thus abruptly moved in the valve closing direction, and the fuel injection port is closed for a very short period of time. Therefore, the fuel injection rate of fuel is abruptly decreased.

In this way, at the start of the fuel injection in the fuel injection apparatus according to the present invention, as described above, the feature of the booster type is well exhibited, and it is possible to realize the relatively gentle increase of the fuel injection rate.

Further, as described above, when the fuel injection is to be stopped, the pressure of the pressure controlling chamber may be increased in advance during the fuel injection. In addition, immediately after boost of the working fluid is stopped, it is possible to maintain the pressure within the pressure controlling chamber at a high level due to the existence of the throttle portion. For this reason, upon the stop of the fuel injection, the high pressure within the pressure controlling chamber may be given to the needle valve in addition to the biasing force of the needle spring. Therefore, as described above, upon the stop of the fuel injection, it is possible to close the fuel injection port at a very high speed and to realize the abrupt reduction of the fuel injection rate.

Moreover, according to the present invention, the booster means, valve controlling means, valve opening means and valve closing means are used in combination so that one valve (booster valve) is simply controlled with a single solenoid to thereby make it possible to perform the fuel injection control.

It is therefore possible to simplify the structure and mechanism of the apparatus and to enhance the reliability.

Further, it is preferable that the port includes a first port and a second port and the throttle portion is provided at least in the first port; and the second port is kept under a condition in which it is in direct communication with the working fluid discharge passage only in the retracted position of the booster piston, and the first port is kept in a condition in communication with the pressurizing chamber only in the case where the booster piston has been advanced through the predetermined distance or longer.

It is possible to take various forms as the port provided with the throttle portion. Among these, in the case where the port is composed of two ports, i.e., a first port and a second port as described above, it is possible to simplify the structure. Note that it is possible to provide the throttle portion not only in the first port but also in the second port.

It is preferable that the valve opening means includes a large diameter portion, a small diameter portion, a stepped portion for connecting said large diameter portion and said small diameter portion with each other in said needle valve, and a fuel stagnation portion is provided in said nozzle chip for surrounding said stepped portion, thereby pressing said stepped portion by the pressure of fuel fed to said fuel stagnation portion to retract said needle valve. In this case, it is possible to readily transmit the increased pressure of the fuel to the needle valve.

It is preferable that the valve closing means has a needle piston disposed slidably within the pressure controlling chamber and in contact with the needle valve, and is adapted such that the needle piston is biased by the working fluid within the pressure controlling chamber and the needle spring. In this case, due to the existence of the needle piston, it is possible to readily realize the mechanism for biasing the needle valve while maintaining an oil tight property within the pressure controlling chamber.

It is also preferable that the booster means has a plunger extending from the booster piston and disposed slidably within the booster chamber, and the plunger is advanced within the booster chamber in accordance with the advancement of the booster piston to increase the pressure of fuel. In this case, the booster piston and the plunger are used in combination so that the structure of each component may be simplified to thereby enhance the manufacture precision.

It is also preferable that a check valve is provided in a fuel feeding passage between the booster chamber and a fuel supply source. In this case, it is possible to readily prevent the counter-flow of the fuel whose pressure has been increased to the fuel supply source.

Further, it is preferable that the working fluid is the fuel. In this case, the fuel is used also as the working fluid to simplify the fluid circuit and to simplify the structure of the periphery of the fuel injection apparatus.

### BRIEF DESCRIPTION OF THE DRAWINGS

In the accompanying drawings:

FIG. 1 is an illustration showing a structure of a fuel injection apparatus according to a first embodiment;

FIG. 2 is an illustration showing a condition in which boost of the fuel injection apparatus is started in accordance with the first embodiment;

FIG. 3 is an illustration showing a condition in which the boost of the fuel injection apparatus is further advance in accordance with the first embodiment;

FIG. 4 is an illustration showing a condition in which the boost of the fuel injection apparatus is stopped in accordance with the first embodiment;

FIG. 5A is an illustration showing a condition in which a booster piston is located in a retracted position in accordance with the first embodiment;

FIG. 5B is an illustration showing a condition in which the booster piston is located in an advanced position within the predetermined distance in accordance with the first embodiment;

FIG. 5C is an illustration showing a condition in which the booster piston is located in an advanced position in or over the predetermined distance in accordance with the first embodiment;

FIG. 6 is an illustration showing a structure of a port and a throttle portion in accordance with a second embodiment;

FIG. 7 is an illustration showing a change of a fuel injection rate in the apparatus according to a third embodiment of the present invention;

FIG. 8 is an illustration showing a change of the fuel injection rate of an accumulator type one for comparison in accordance with the third embodiment; and

FIG. 9 is an illustration showing a change of the fuel injection rate of a booster type one for comparison in accordance with the third embodiment.

### DESCRIPTION OF THE PREFERRED EMBODIMENTS

Embodiment 1

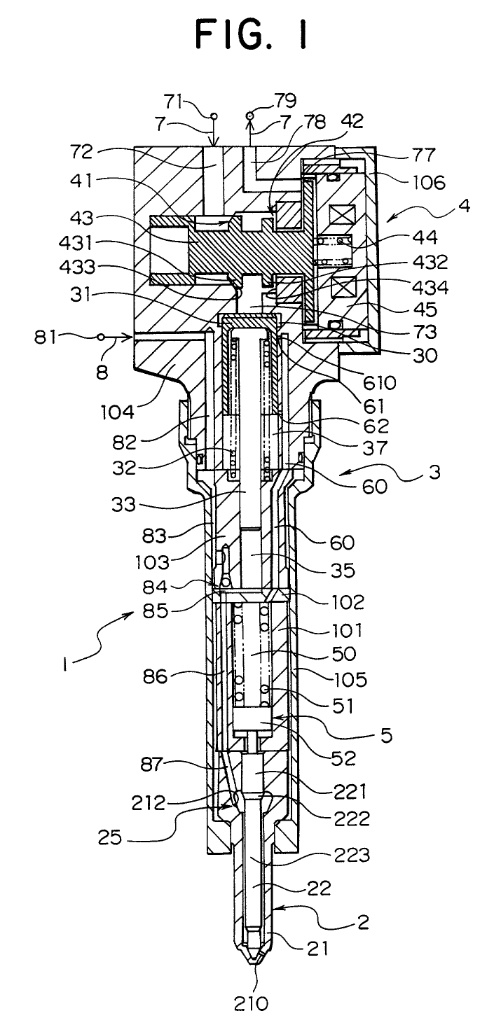

A fuel injection apparatus for compression combustion engine (Diesel engine) in accordance with an embodiment of the invention will now be described with reference to FIGS. 1 to 5C.

As shown in FIG. 1, the fuel injection apparatus 1 according to the embodiment has a valve body portion 2 is composed of a nozzle chip 21 provided with a fuel injection port 210 and a needle valve 22 disposed movably back and forward within the nozzle chip 21 for opening and closing the fuel injection port 210.

A valve opening means 25 is provided in the valve body portion 2 for biasing the needle valve 22 in a direction in which the fuel injection port 210 is opened by means of the increased pressure of fuel 8.

In the valve opening means 25, a large diameter portion 221, a small diameter portion 223, and a stepped portion 222 for connecting a large diameter portion 221 and a small diameter portion 223 are provided in the needle valve 22, a fuel stagnation portion 212 surrounding the stepped portion 222 is provided in the nozzle chip 21, and the stepped portion 222 is pressed by means of the pressure of the fuel 8 fed to the fuel stagnation portion 212 to retract the needle valve 21.

Further, the fuel stagnation portion 212 is in communication with a booster chamber 35 (described later) through fuel feeding passages 85, 86 and 87.

Moreover, as shown in FIG. 1, the fuel injection apparatus 1 has a booster means 3.

The booster means 3 is so constructed that a booster piston 31 that is movable back and forward and biased backward by a piston spring 32 is advanced against the biasing force of the piston spring 32 by a pressure of working fluid 7 led into a pressurizing chamber 30 to thereby increase the pressure of the fuel 8 within the booster chamber 35.

Further, the booster means 3 has a plunger 33 extending from the booster piston 31 and slidably disposed in the booster chamber 35. The plunger 33 is advanced within the booster chamber 35 in accordance with the advancement of the booster piston 31 to increase the pressure of the fuel 8.

The booster chamber 35 is in communication with a fuel supply source 81 through the fuel feeding passage 85, a check valve 84, fuel feeding passages 83 and 82, and at the same time, as described above, is in communication with the fuel stagnation portion 212 through the fuel feeding passages 85, 86 and 87.

The check valve 84 is adapted so as to be closed when the pressure within the booster chamber 35 is higher than that of the fuel supply source.

Also, as shown in FIG. 1, the fuel injection apparatus 1 has a feeding port 41 for communicating the pressurizing chamber 30 and a working fluid supply source 71 with each other, a discharge port 42 for communicating the pressurizing chamber 30 and a working fluid discharge passage 79 with each other, and a booster valve 43 for opening and closing the feeding port 41 and the discharge port 42.

The feeding port 41 is located between a working fluid passage 72 in communication with the working fluid supply source 71 and a working fluid passage 73 in communication with the pressurizing chamber 30 and adapted to be closed and opened in accordance with the change in contact condition between a flange portion 431 of the booster valve 43 and a valve seat 433.

Further, the discharge port 42 is located between a working fluid passage 77 in communication with the working fluid discharge passage 79 through a working fluid passage 78 and the working fluid passage 73 and adapted to be opened and closed in accordance with the change in contact condition between a flange portion 432 of the booster valve 43 and a valve seat 434.

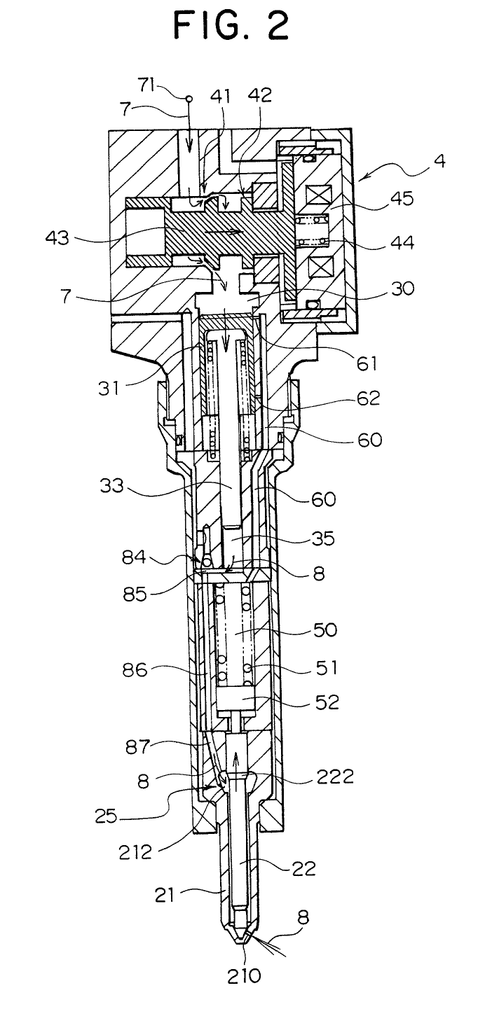

The booster valve 43 is disposed to be movable between a pressure decreasing position (in the condition shown in FIG. 1) for closing the feeding port 41 and for opening the discharge port 42 and a booster position (in the condition shown in FIG. 2) for opening the feeding port 41 and for closing the discharge port 42.

A valve controlling means 4 for controlling this booster valve 43 is composed of a valve spring 44 for biasing the booster valve 43 toward the pressure decreasing position and a solenoid 45 for moving the booster valve 43 to the booster position.

In addition, as shown in FIG. 1, the fuel injection apparatus 1 has a valve closing means 5 for biasing the needle valve 22 in the direction in which the fuel injection port 210 is closed by the pressure of the working fluid 7 led into a pressure controlling chamber 50 and the biasing force of a needle spring 51. The valve closing means 5 has a needle piston 52 disposed slidably within the pressure controlling chamber 50 and in contact with the needle valve 22 and adapted to bias the needle piston 52 by the working fluid 7 within the pressure controlling chamber 50 and the needle spring 51.

A working fluid introducing/backing passage 60 having a first port 61 and a second port 62 for introducing/backing the working fluid 7 is connected to the pressure controlling chamber 50. A throttle portion 610 for imparting the fluidization resistance to the working fluid 7 is provided in the first port 61. In this example, the throttle portion 610 is formed by reducing the diameter of the first port 61 as a whole more than that of the working fluid introducing/backing passage 60. Note that the throttle portion 610 may be changed and modified into a variety of forms, for example, in which the throttle portion 610 is interposed between the first port 61 and the working fluid introducing/backing passage 60.

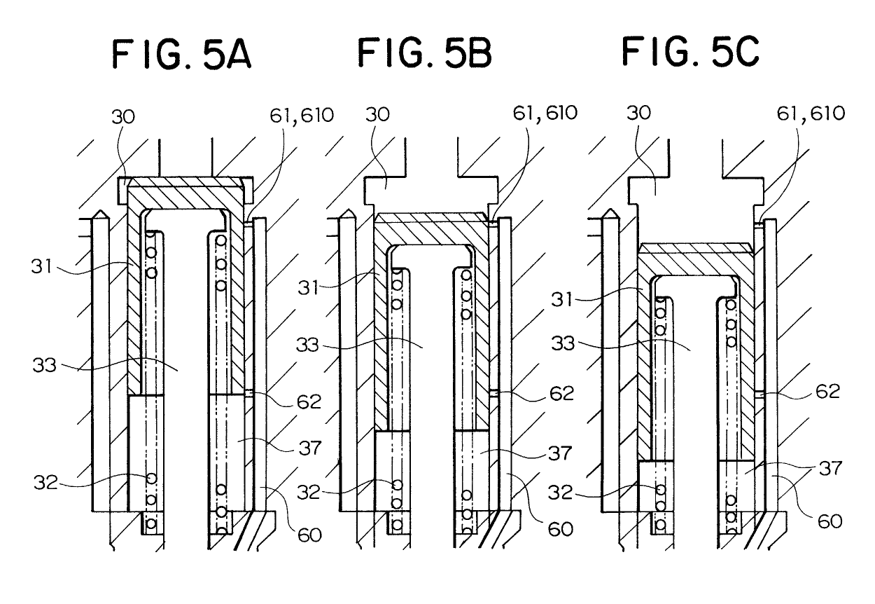

As shown in FIGS. 5A to 5C, the second port 62 is kept under the condition in which it is in direct contact with the sliding chamber 37 only in the retracted position of the booster piston 31. The first port 61 is adapted to be in communication with the pressurizing chamber 30 only in the case where the booster piston 31 is advanced in or over the predetermined distance.

Namely, as shown in FIG. 5A, the first port 61 is closed by a side wall of the booster piston 31 under the condition in which the booster piston 31 is retracted, whereas the second port 62 is half-opened at the lower end of the booster piston 31. Thus, the second port 62 is in communication with a sliding chamber 37 in which the booster piston 31 is slidingly moved. The sliding chamber 37 is in communication with the working fluid discharge passage 79 through a working fluid passage (not shown). Accordingly, when the booster piston 31 is in the retracted position, the working fluid introducing/backing passage 60 is kept in communication with the working fluid discharge passage 79 through the second port 62.

Further, as shown in FIG. 5B, when the booster piston 31 is advanced from the retracted position, the first port 61 and the second port 62 are kept under the closed condition by the side wall of the piston 31.

Moreover, as shown in FIG. 5C, in the case where the booster piston 31 is advanced through the predetermined distance or longer, the second port 62 is kept under the closed condition by the side wall of the booster piston 31 but the first port 61 is in communication with the pressurizing chamber 30. Under this condition, the pressurizing chamber 30 is kept in cooperation with the condition that it is in communication with either the working fluid supply source 71 or the working fluid discharge passage 79.

In addition, as shown in FIG. 1, the fuel injection apparatus 1 has bodies 101 to 104 for defining the components, a case 105 surrounding the valve body portion 2 and them, and a case 106 surrounding the solenoid 45.

The operation effect of the fuel injection apparatus 1 according to this embodiment will now be described.

As shown in FIG. 2, in the fuel injection apparatus 1, when the fuel is to be injected, the booster valve 43 is moved to the booster position by the solenoid of the valve controlling means 4. Thus, the discharge port 42 is closed and at the same time the feeding port 41 is opened. The pressurizing chamber 30 of the booster means 3 and the working fluid supply source 71 are in communication with each other. Accordingly, the working fluid 7 is introduced into the pressurizing chamber 30 to increase the pressure of the pressurizing chamber 30.

As shown in FIG. 2, the booster piston 31 and the plunger 33 are gradually advanced by the increase of the pressure within the pressurizing chamber 30, and the pressure of the fuel 8, stored in advance, within the booster chamber 35 is gradually increased. The check valve 84 is closed by the increased pressure of the fuel 8, and the fuel 8 is fed to the fuel stagnation portion 212 through the fuel feeding passages 85, 86 and 87. Then, the pressure within the fuel stagnation portion 212 is increased and the valve opening force of the valve opening means 25, i.e., the pressing force of the needle valve 22 to the stepped portion 222 is increased.

On the other hand, as shown in FIG. 5A, before the start of advancement of the booster piston, the second port 62 of the working fluid introducing/backing passage 60 connected to the pressure controlling chamber 50 is in communication with the working fluid discharge passage 79. For this reason, the pressure controlling chamber 50 before the start of the boost is under a low pressure condition, and the valve closing force for biasing the needle valve 22 in the valve opening direction is maintained only by means of the biasing force of the needle spring 51.

Also, as shown in FIG. 5B, after the start of the boost, since the first port 61 and the second port 62 are closed until the booster piston 31 is advanced through the predetermined distance, the interior of the pressure controlling chamber 50 is kept under the low pressure condition.

For this reason, as shown in FIG. 2, the needle valve 22 is moved in the valve opening direction at the time the valve opening biasing force for pressing the stepped portion 222 by the pressure of the fuel 8 overcomes the biasing force of the needle spring 51, and the fuel injection port 210 is opened to start the injection of the fuel 8.

Then, in accordance with the further advancement of the booster piston 31, the pressure of the fuel is further increased, and the fuel injection rate of the fuel to be injected is increased in accordance with this.

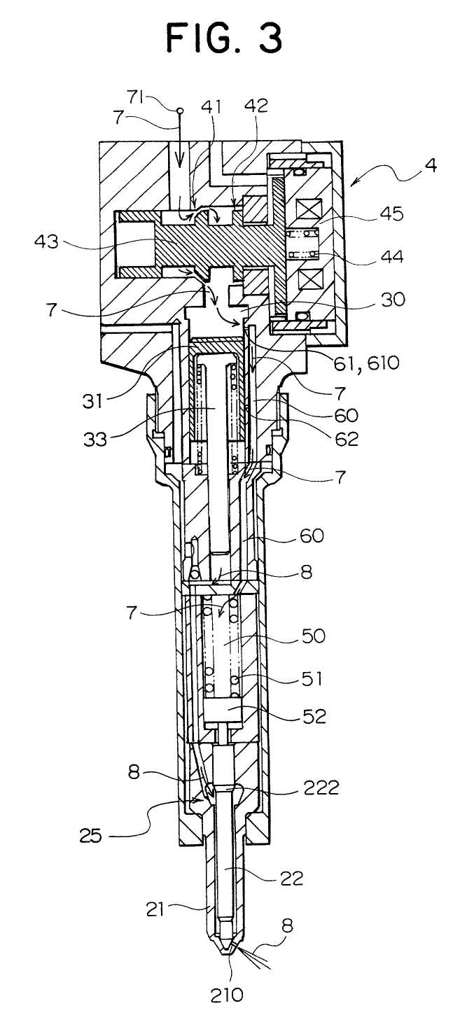

As shown in FIG. 3 and FIG. 5C, the first port 61 connected to the pressure controlling chamber 50 is in communication with the pressurizing chamber 30 at the time the advancement of the booster piston 31 exceeds the predetermined level. For this reason, the working fluid 7 is introduced from the pressurizing chamber 30 through the first port 61 (throttle portion 610) and the working fluid introducing/backing passage 60 to the pressure controlling chamber 50. Thus, the pressure within the pressure controlling chamber 50 is increased and kept at a high pressure condition.

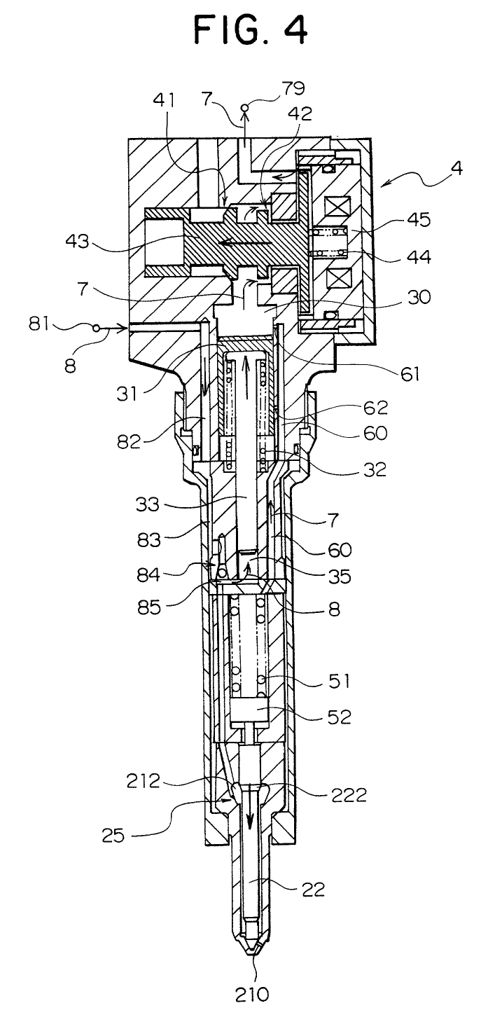

Subsequently, when the fuel injection is interrupted, as shown in FIG. 4, the operation of the solenoid 45 of the valve controlling means 4 is stopped. Thus, the booster valve 43 is returned back to the pressure decreasing position by the biasing force of the valve spring 44. Then, the feeding port 41 is closed and at the same time the discharge port 42 is kept under the open condition. For this reason, the pressurizing chamber 30 is in communication with the working fluid discharge passage 79 to bring about the abrupt pressure decreasing condition.

The advancement of the booster piston 31 and the plunger 33 is stopped by means of the decreased pressure of the pressurizing chamber 30. Thus, the pressure of the fuel 8 is decreased so that the pressure within the fuel stagnation portion 212 in the valve opening means 25 is decreased to reduce the valve opening force.

On the other hand, the working fluid 7 kept under the high pressure condition within the pressure controlling chamber 50 is discharged through the first port 61. However, since the throttle portion 610 is provided in the port 61, the discharge of the working fluid 7 is controlled to be suppressed at a very low flow rate. Thus, the interior of the pressure controlling chamber 50 is maintained at a sufficiently high pressure immediately after the boost is stopped.

For this reason, at the moment the pressure of the fuel 8 is reduced to decrease the valve opening force as described above, a large valve closing force resultant from the combination of the high pressure of the pressure controlling chamber 50 and the biasing force of the needle spring 52 is given to the needle valve 22. For this reason, the needle valve 22 is abruptly moved in the valve closing direction so that the fuel injection port 210 is closed for a very short period of time. Therefore, the fuel injection rate of the fuel 8 is abruptly dropped.

Thereafter, the booster piston 31 and the plunger 33 are returned back to the retracted position by the biasing force of the piston spring 32. Also, the fuel is stored through the fuel feeding passages 82, 83 and 85 from the fuel supply source 81 to the booster chamber 35 while the check valve 84 is opened in pressure balance relation.

Further, under the high pressure condition within the pressure controlling chamber 50, as shown in FIGS. 3 and 5C, the working fluid 7 is discharged gradually from the first port 61 (throttle portion 610) when the first port 61 is opened during the retraction of the booster piston 31. As shown in FIGS. 1 and 5A, after the booster piston 31 is completely returned back to the retracted position, the working fluid 7 is discharged from the second port 62 to bring about the low pressure condition.

Thus, in the fuel injection start in the fuel injection apparatus according to the present invention, as described above, it is possible to effectively exhibit the feature of the booster type to realize the relatively moderate fuel injection rate increase.

Further, when the injection of fuel is to be stopped, it is possible to increase the pressure of the pressure controlling chamber 50 in advance during the fuel injection. In addition, even immediately after the boost of the working fluid 7 has been stopped, it is possible to maintain the high pressure level due to the existence of the throttle portion 610 in the pressure controlling chamber 50. For this reason, as described above, in the interruption of the fuel injection of the fuel 8, the high pressure within the pressure controlling chamber 50 may be applied to the needle valve 22 in addition to the biasing force of the needle spring 51. Therefore, in the interruption of the fuel injection of the fuel 8, it is possible to close the fuel injection port 210 at a very high speed to thereby make it possible to realize the abrupt reduction of the fuel injection rate.

Furthermore, in the fuel injection apparatus 1 according to this embodiment, the booster means 3, valve controlling means 4, valve opening means 25 and valve closing means 5 are used in combination so that the fuel injection control may be performed only by controlling one valve (booster valve 43) with the one solenoid 45.

Accordingly, it is possible to simplify the structure and mechanism of the apparatus and to enhance the reliability.

Embodiment 2

This embodiment is directed to a change of the structure of the ports 61 and 62 and the throttle portion 610 in the fuel injection apparatus 1 according to the first embodiment.

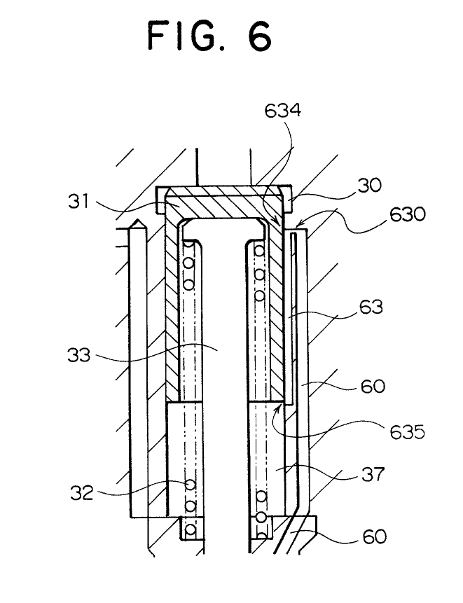

Namely, as shown in FIG. 6, in this embodiment, an elongated port 63 is provided and a throttle portion 630 is provided between this port 63 and the working fluid introducing/backing passage 60. The port 63 is in communication with the sliding chamber 37 only on the side of a lower end 635 when the booster piston 31 is in the retracted position. When the booster piston 31 is advanced through the predetermined distance or longer, an upper end side 634 is released to the pressurizing chamber 30.

The other structure is the same as that of the first embodiment.

In this case, the same effect as that of the first embodiment may be insured.

Also, in this embodiment, the fuel injection apparatus 1 according to the first embodiment was used, the injection of fuel and interruption thereof were performed, and the change of the fuel injection rate during this period was measured. Further, for comparison, an accumulator fuel injection apparatus and a booster type fuel injection apparatus were prepared, and the same experiments were conducted.

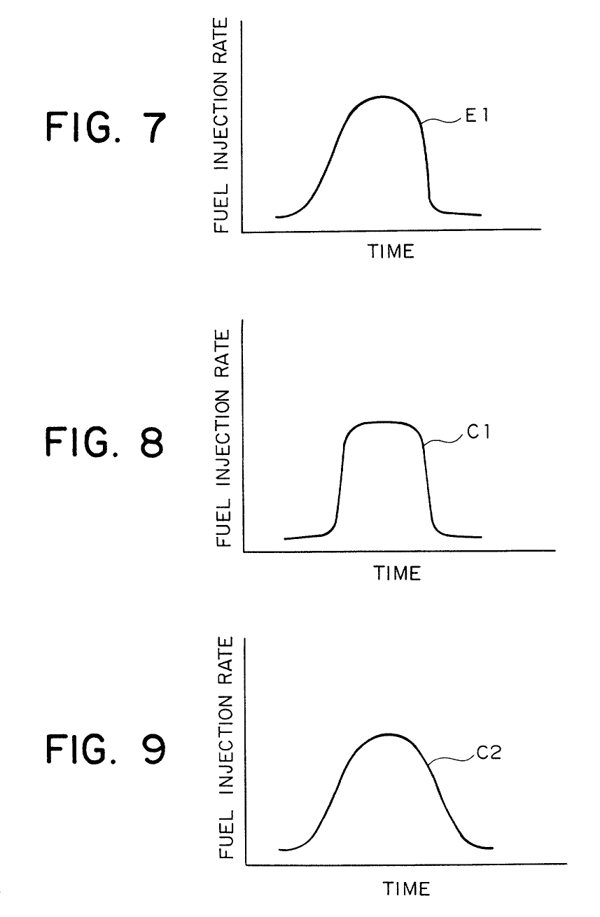

FIGS. 7 to 9 show the measurement results. In FIG. 7, the result of the fuel injection apparatus 1 in accordance with the first embodiment is indicated by a solid line E1. In FIG. 8, the result of the accumulator fuel injection apparatus is indicated by a solid line C1. In FIG. 9, the result of the booster type fuel injection apparatus is indicated by a solid line C2. In these drawings, the abscissa represents time and the ordinate represents the fuel injection rate.

As is apparent from FIGS. 7 to 9, it is understood that the fuel injection apparatus 1 according to the present invention has excellent characteristics with the accumulator type and the booster type. Namely, as shown in FIG. 7, upon the start of the fuel injection, the increase of the fuel injection rate is relatively moderate as in the booster type (FIG. 9), and upon the interruption of the fuel injection, the reduction of the fuel injection rate may be abruptly performed as in the accumulator type (FIG. 8).

As described above, according to the present invention, it is possible to keep the fuel injection rate in the optimum condition upon the start of the fuel injection and upon the interruption of the fuel injection and to provide a fuel injection apparatus that is relatively simple in structure and high in reliability.

What is claimed is:

1. A fuel injection apparatus comprising:
a valve body portion including a nozzle chip provided with a fuel injection port and a needle valve disposed movably back and forward within said nozzle chip for opening and closing said fuel injection port;
a booster means for advancing a booster piston, movable back and forward and biased backwardly by a piston spring, against a biasing force of said piston spring by a pressure of working fluid introduced into a pressurizing chamber to increase the pressure of fuel within a booster chamber;
a valve controlling means including a feeding port for communicating said pressurizing chamber and a working fluid supply source with each other, a discharge port for communication with said pressurizing chamber and a working fluid discharge passage, a booster valve for opening and closing said feeding port and said discharge port, a valve spring for closing said feeding port and biasing said booster valve toward a pressure decreasing position where said discharge port is released, and a solenoid for releasing said feeding port and moving said booster valve to a booster position where said discharge port is closed;
a valve opening means for biasing said needle valve in a direction in which said fuel injection port is released by the increased pressure of fuel; and
a valve closing means for biasing said needle valve in a direction in which said fuel injection port is closed by a pressure of working fluid introduced into a pressure controlling chamber and a biasing force of a needle spring;
wherein a working fluid introducing/backing passage having a port for performing introduction and discharge of the working fluid is connected to said pressure controlling chamber, and a throttle portion for imparting a fluidization resistance to the working fluid is provided in said port; and
wherein said port is adapted to become a condition in which it is in communication with said working fluid discharge passage only at the retracted position of said booster piston, to become a condition in which it is in communication with said pressurizing chamber only in the case where said booster piston is advanced through a predetermined distance or longer, and to become a closed condition in communication with none of said working fluid discharge passage and said pressurizing chamber from said retracted position to said position through said predetermined distance.

2. A fuel injection apparatus according to claim 1, wherein said port includes a first port and a second port and said throttle portion is provided at least in said first port; and
wherein said second port is kept under a condition in which it is in direct communication with said working fluid discharge passage only in the retracted position of said booster piston, and said first port is kept in a condition in which it is in communication with said pressurizing chamber only in the case where said booster piston has been advanced through the predetermined distance or longer.

3. A fuel injection apparatus according to claim 2, wherein said second port is kept under a half-open condition at a lower end of said booster piston when said second port is in communication with said working fluid discharge passage.

4. A fuel injection apparatus according to claim 1, wherein said valve opening means includes a large diameter portion, a small diameter portion, a stepped portion for connecting said large diameter portion and said small diameter portion with each other in said needle valve, and a fuel stagnation portion is provided in said nozzle chip for surrounding said stepped portion, thereby pressing said stepped portion by the pressure of fuel fed to said fuel stagnation portion to retract said needle valve.

5. A fuel injection apparatus according to claim 1, wherein said valve closing means has a needle piston disposed slidably within said pressure controlling chamber and in contact with said needle valve, and is adapted such that said needle piston is biased by the working fluid within said pressure controlling chamber and the needle spring.

6. A fuel injection apparatus according to claim 1, wherein said booster means has a plunger extending from said booster piston and disposed slidably within said booster chamber, and said plunger is advanced within said booster chamber in accordance with the advancement of said booster piston to increase the pressure of fuel.

7. A fuel injection apparatus according to claim 1, wherein a check valve is provided in a fuel feeding passage between said booster chamber and a fuel supply source.

8. A fuel injection apparatus according to claim 1, wherein the working fluid is said fuel.

9. A fuel injection apparatus according to claim 1, wherein said port includes an elongated port, and said throttle portion is provided between said port and said working fluid introducing/backing passage; and
wherein said port is released only at the lower side to a sliding chamber when said booster piston is in the retracted position and at the upper side to said pressurizing chamber in the case where said booster piston has been advanced through the predetermined distance or longer.
